(19) United States
(12) Patent Application Publication
(10) Pub. No.: US 2025/0240425 A1
(43) Pub. Date: Jul. 24, 2025

(54) Method and Apparatus of Using Separate Splitting Trees for Colour Components in Video Coding System

(71) Applicant: MEDIATEK INC., Hsinchu City (TW)

(72) Inventors: Chun-Chia CHEN, Hsinchu City (TW); Shih-Ta HSIANG, Hsinchu City (TW); Tzu-Der CHUANG, Hsinchu City (TW); Chih-Wei HSU, Hsinchu City (TW); Ching-Yeh CHEN, Hsinchu City (TW); Yu-Wen HUANG, Hsinchu City (TW)

(21) Appl. No.: 18/855,490

(22) PCT Filed: Mar. 20, 2023
(86) PCT No.: PCT/CN2023/082470

§ 371 Date: Oct. 9, 2024

Related U.S. Application Data
(60) Provisional application No. 63/330,342, filed on Apr. 13, 2022.

(51) Int. Cl. H04N 19/13; H04N 19/119; H04N 19/172; H04N 19/176; H04N 19/186; H04N 19/70

(52) U.S. Cl. CPC H04N 19/13; H04N 19/119; H04N 19/172; H04N 19/176; H04N 19/186; H04N 19/70

(57) ABSTRACT

A method and apparatus for video coding. According to the method, input data associated with a picture area having a first-colour picture area and a second-colour picture area are received, where the input data comprise pixel data for the picture area to be encoded at an encoder side or coded data associated with the picture area to be decoded at a decoder side, and where the first-colour picture area is partitioned into one or more first-colour blocks according to a first-colour splitting tree and the second-colour picture area is partitioned into one or more second-colour blocks according to a second-colour splitting tree. Entropy encoding or decoding is applied to the second-colour splitting tree using context formation, where the context formation has information related to the first-colour splitting tree. The one or more first-colour blocks and the one or more second-colour blocks are then encoded or decoded.

### CROSS REFERENCE TO RELATED APPLICATIONS

The present invention is a non-Provisional Application of and claims priority to U.S. Provisional Patent Application No. 63/330,342, filed on Apr. 13, 2022. The U.S. Provisional Patent Application is hereby incorporated by reference in its entirety.

### FIELD OF THE INVENTION

The present invention relates to video coding system. In particular, the present invention relates to partitioning colour blocks using separate chroma splitting tree and entropy of splitting trees in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

The VVC standard incorporates various new coding tools to further improve the coding efficiency over the HEVC standard. Among various new coding tools, some coding tools relevant to the present invention are reviewed as follows.

Partitioning of the Picture into CTUs

Pictures are divided into a sequence of coding tree units (CTUs). The CTU concept is same to that of the HEVC. For a picture that has three sample arrays, a CTU consists of an N×N block of luma samples together with two corresponding blocks of chroma samples. FIG. 2 shows an example of a picture divided into CTUs, where the thick-lined box 210 corresponds to a picture and each small rectangle (e.g. box 220) corresponds to one CTU.

The maximum allowed size of the luma block in a CTU is specified to be 128×128 (although the maximum size of the luma transform blocks is 64×64).

Partitioning of Pictures into Subpictures, Slices, Tiles

A picture is divided into one or more tile rows and one or more tile columns. A tile is a sequence of CTUs that covers a rectangular region of a picture.

A slice consists of an integer number of complete tiles or an integer number of consecutive complete CTU rows within a tile of a picture.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture contains one or more slices that collectively cover a rectangular region of a picture.

FIG. 3 shows an example of raster-scan slice partitioning of a picture 310, where the picture is divided into 12 tiles 314 (and 3 raster-scan slices 316. Each small rectangle 312 corresponds to one CTU.

FIG. 4 shows an example of rectangular slice partitioning of a picture 410, where the picture is divided into 24 tiles 414 (6 tile columns and 4 tile rows) and 9 rectangular slices 416. Each small rectangle 412 corresponds to one CTU.

FIG. 5 shows an example of a picture 510 partitioned into tiles and rectangular slices, where the picture 510 is divided into 4 tiles 514 (2 tile columns and 2 tile rows) and 4 rectangular slices 516. Each small rectangle 512 corresponds to one CTU.

FIG. 6 shows an example of subpicture partitioning of a picture 610, where the picture 610 is partitioned into 18 tiles 614, 12 on the left-hand side each covering one slice of 4 by 4 CTUs and 6 tiles on the right-hand side each covering 2 vertically-stacked slices of 2 by 2 CTUs, altogether resulting in 24 slices 616 and 24 subpictures 616 of varying dimensions (each slice is also a subpicture). Each small rectangle 612 corresponds to one CTU.

### Partitioning of the CTUs Using a Tree Structure

In HEVC, a CTU is split into CUs by using a quaternary-tree (QT) structure denoted as coding tree to adapt to various local characteristics. The decision regarding whether to code a picture area using inter-picture (temporal) or intra-picture (spatial) prediction is made at the leaf CU level. Each leaf CU can be further split into one, two or four PUs (Prediction Units) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 7, there are four splitting types in multi-type tree structure, vertical binary splitting (SPLIT_BT_VER 710), horizontal binary splitting (SPLIT_BT_HOR 720), vertical ternary splitting (SPLIT_TT_VER 730), and horizontal ternary splitting (SPLIT_TT_HOR 740). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 8 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| | mtt_split_cu_{—} | mtt_split_cu_{—} |
|---|---|---|
| MttSplitMode | vertical_flag | binary_flag |
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 9 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined and specified by SPS syntax elements for the quadtree with nested multi-type tree coding tree scheme.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinBtSize: the minimum allowed binary tree leaf node size
MinTtSize: the minimum allowed ternary tree leaf node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinBtSize and MinTtSize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinBtSize and smaller or equal to 2*MinTtSize, no further horizontal splitting is considered. Similarly, when the multi-type tree node has height equal to MinBtSize and smaller or equal to 2*MinTtSize, no further vertical splitting is considered.

To allow 64×64 Luma block and 32×32 Chroma pipelining design in VVC hardware decoders, TT split is forbidden when either width or height of a luma coding block is larger than 64, as shown in FIG. 10, where block 1000 corresponds to a 128×128 luma CU. The CU can be split using vertical binary partition (1010) or horizontal binary partition (1020). After the block is split into 4 CUs, each size is 64×64, the CU can be further partitioned using partitions including TT. For example, the upper-left 64×64 CU is partitioned using vertical ternary splitting (1030) or horizontal ternary splitting (1040). TT split is also forbidden when either width or height of a chroma coding block is larger than 32.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three color components unless the video is monochrome.

### CU Splits on Picture Boundaries

As done in HEVC, when a portion of a tree node block exceeds the bottom or right picture boundary, the tree node block is forced to be split until all samples of every coded CU are located inside the picture boundaries. The following splitting rules are applied in the VVC:
If any portion of a tree node block exceeds the bottom or the right picture boundaries, and any of QT, BT and TT splitting is not allowed due to block size restriction, the block is forced to be split with QT split mode.
Otherwise if a portion of a tree node block exceeds both the bottom and the right picture boundaries,
   If the block is a QT node and the size of the block is larger than the minimum QT size, the block is forced to be split with QT split mode.
   Otherwise, the block is forced to be split with SPLIT_BT_HOR mode
Otherwise if a portion of a tree node block exceeds the bottom picture boundaries,
   If the block is a QT node, and the size of the block is larger than the minimum QT size, and the size of the block is larger than the maximum BT size, the block is forced to be split with QT split mode.
   Otherwise, if the block is a QT node, and the size of the block is larger than the minimum QT size and the size of the block is smaller than or equal to the maximum BT size, the block is forced to be split with QT split mode or SPLIT_BT_HOR mode.
   Otherwise (the block is a BTT node or the size of the block is smaller than or equal to the minimum QT size), the block is forced to be split with SPLIT_BT_HOR mode.
Otherwise if a portion of a tree node block exceeds the right picture boundaries,
   If the block is a QT node, and the size of the block is larger than the minimum QT size, and the size of the block is larger than the maximum BT size, the block is forced to be split with QT split mode.
   Otherwise, if the block is a QT node, and the size of the block is larger than the minimum QT size and the size of the block is smaller than or equal to the maximum BT size, the block is forced to be split with QT split mode or SPLIT_BT_VER mode.
   Otherwise (the block is a BTT node or the size of the block is smaller than or equal to the minimum QT size), the block is forced to be split with SPLIT_BT_VER mode.

### Restrictions on Redundant CU Splits

The quadtree with nested multi-type tree coding block structure provides a highly flexible block partitioning structure. Due to the types of splits supported the multi-type tree, different splitting patterns could potentially result in the same coding block structure. In VVC, some of these redundant splitting patterns are disallowed.

FIG. 11 illustrates the redundant splitting patterns of binary tree splits and ternary tree splits. As shown in FIG. 11, two levels of consecutive binary splits in one direction (vertical 1110 and horizontal 1130) could have the same coding block structure as a ternary tree split (vertical 1120 and horizontal 1140) followed by a binary tree split of the central partition. In this case, the binary tree split (in the given direction) for the central partition of a ternary tree split is prevented by the syntax. This restriction applies for CUs in all pictures.

When the splits are prohibited as described above, signalling of the corresponding syntax elements is modified to account for the prohibited cases. For example, when any case in FIG. 11 is identified (i.e. the binary split is prohibited for a CU of a central partition), the syntax element mtt_split_cu_binary_flag which specifies whether the split is a binary split or a ternary split is not signalled and is instead inferred to be equal to 0 by the decoder.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 12:
TT split is not allowed (as indicated by “X” in FIG. 12) for a CU with either width or height, or both width and height equal to 128.
For a 128×N CU with N≤64 (i.e. width equal to 128 and height smaller than 128), horizontal BT is not allowed.

For an N×128 CU with N≤64 (i.e. height equal to 128 and width smaller than 128), vertical BT is not allowed. In FIG. 12, the luma block size is 128×128. The dashed lines indicate block size 64×64. According to the constraints mentioned above, examples of the partitions not allowed are indicated by “X” as shown in various examples (1210-1280) in FIG. 12.

### Intra Chroma Partitioning and Prediction Restriction

In typical hardware video encoders and decoders, processing throughput drops when a picture has more small intra blocks because of sample processing data dependency between neighbouring intra blocks. The predictor generation of an intra block requires top and left boundary reconstructed samples from neighbouring blocks. Therefore, intra prediction has to be sequentially processed block by block.

In HEVC, the smallest intra CU is 8×8 luma samples. The luma component of the smallest intra CU can be further split into four 4×4 luma intra prediction units (Pus), but the chroma components of the smallest intra CU cannot be further split. Therefore, the worst case hardware processing throughput occurs when 4×4 chroma intra blocks or 4×4 luma intra blocks are processed. In VVC, in order to improve worst case throughput, chroma intra CBs smaller than 16 chroma samples (size 2×2, 4×2, and 2×4) and chroma intra CBs with width smaller than 4 chroma samples (size 2×N) are disallowed by constraining the partitioning of chroma intra CBs.

In single coding tree, a smallest chroma intra prediction unit (SCIPU) is defined as a coding tree node whose chroma block size is larger than or equal to 16 chroma samples and has at least one child luma block smaller than 64 luma samples, or a coding tree node whose chroma block size is not 2×N and has at least one child luma block 4×N luma samples. It is required that in each SCIPU, all CBs are inter, or all CBs are non-inter, i.e., cither intra or intra block copy (IBC). In case of a non-inter SCIPU, it is further required that chroma of the non-inter SCIPU shall not be further split and luma of the SCIPU is allowed to be further split. In this way, the small chroma intra CBs with size less than 16 chroma samples or with size 2×N are removed. In addition, chroma scaling is not applied in case of a non-inter SCIPU. Here, no additional syntax is signalled, and whether a SCIPU is non-inter can be derived by the prediction mode of the first luma CB in the SCIPU. The type of a SCIPU is inferred to be non-inter if the current slice is an I-slice or the current SCIPU has a 4×4 luma partition in it after further split one time (because no inter 4×4 is allowed in VVC); otherwise, the type of the SCIPU (inter or non-inter) is indicated by one flag before parsing the CUs in the SCIPU.

For the dual tree in intra picture, the 2×N intra chroma blocks are removed by disabling vertical binary and vertical ternary splits for 4×N and 8×N chroma partitions, respectively. The small chroma blocks with sizes 2×2, 4×2, and 2×4 are also removed by partitioning restrictions.

In addition, a restriction on picture size is considered to avoid 2×2/2×4/4×2/2×N intra chroma blocks at the corner of pictures by considering the picture width and height to be multiple of max (8, MinCbSize Y).

### CST (Chroma Separate Tree) in VVC

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

In VVC, the luma and chroma components use separate splitting trees to partition a CTU into CUs. While the separate splitting trees may adapt to different local characteristics between the luma and chroma components, it will require more coded bits to represent the separate splitting trees. Accordingly, it is desirable to improve the coding efficiency of separate splitting trees. Furthermore, it is also desirable to apply separate splitting trees to different chroma components to improve coding efficiency.

### BRIEF SUMMARY OF THE INVENTION

A method and apparatus for video coding are disclosed. According to the method, input data associated with a picture area comprising a first-colour picture area and a second-colour picture area are received, wherein the input data comprise pixel data for the picture area to be encoded at an encoder side or coded data associated with the picture area to be decoded at a decoder side, and wherein the first-colour picture area is partitioned into one or more first-colour blocks according to a first-colour splitting tree and the second-colour picture area is partitioned into one or more second-colour blocks according to a second-colour splitting tree. Entropy encoding or decoding is applied to the second-colour splitting tree using context formation, wherein the context formation comprises information related to the first-colour splitting tree. Said one or more first-colour blocks and said one or more second-colour blocks are encoded or decoded.

In one embodiment, the context formation is dependent on quadtree depth or MTT (Multi-Type Tree) depth related to the first-colour splitting tree, or block dimension related to said one or more first-colour blocks.

In one embodiment, the context formation for entropy coding a split decision for a current second-colour block is dependent on splitting situation in a corresponding first-colour block.

In one embodiment, the context formation for entropy coding a split flag associated with a current second-colour block is dependent on a block size of a corresponding first-colour block.

In one embodiment, the context formation for entropy coding an MTT (Multi-Type Tree) vertical flag for a current second-colour block is dependent on dimension of a corresponding first-colour block. The dimension of the corresponding first-colour block may correspond to width, height or both the width and the height of the corresponding first-colour block.

In one embodiment, the first-colour picture area corresponds to a luma picture area and the second-colour picture area corresponds to a chroma picture area.

In one embodiment, the picture area comprises a third-colour picture area, and wherein the first-colour picture area corresponds to a luma picture area, the second-colour picture area corresponds to a first chroma picture area and the third-colour picture area corresponds to a second chroma picture area. In one embodiment, the third-colour picture area is partitioned into one or more third-colour blocks according to a third-colour splitting tree separately from the second-colour splitting tree.

In one embodiment, a syntax is signalled or parsed in picture level, a slice level, a tile level, a CTU-row level, a CTU level, a VPDU level or a combination thereof, and wherein the syntax is related to indicating whether the third-colour splitting tree used to partition the third-colour picture area is separately from the second-colour splitting tree at a corresponding picture, slice, tile, CTU-row, CTU or VPDU.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows an example of a picture divided into CTUs

FIG. 3 shows an example of raster-scan slice partitioning of a picture, where the picture is divided into 12 tiles and 3 raster-scan slices.

FIG. 4 shows an example of a picture partitioned into tiles and rectangular slices

FIG. 5 shows an example of a picture partitioned into 4 tiles and 4 rectangular slices

FIG. 6 shows an example of a picture partitioned into 24 subpictures

FIG. 7 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 8 illustrates an example of the signalling mechanism of the partition splitting information in quadtree with nested multi-type tree coding tree structure.

FIG. 9 shows an example of a CTU divided into multiple CUs with a quadtree and nested multi-type tree coding block structure, where the bold block edges represent quadtree partitioning and the remaining edges represent multi-type tree partitioning.

FIG. 10 shows an example of TT split forbidden when either width or height of a luma coding block is larger than 64.

FIG. 11 illustrates an example of the redundant splitting patterns of binary tree splits and ternary tree splits.

FIG. 12 shows some examples of TT split forbidden when either width or height of a luma coding block is larger than 64.

FIG. 13 illustrates an example where the luma and chroma can have different trees for an inter slice and it will be more efficient to generate a chroma predictor as a whole parent block.

FIG. 14 illustrates a flowchart of an exemplary video coding system that utilizes separate splitting trees for luma and chroma components according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the following, techniques to improve the coding performance realted to coding trees are disclosed.

### Method A: CST (Chroma Separate Tree) for Cb and Cr

Instead of the VVC CST, in which the Cb and Cr shares the same splitting tree, the Cb is allowed to have its own splitting tree and Cr is allowed to have its own separate splitting tree according to embodiments of the present invention.

To save the partition signaling bits, the splitting context probability can be referred between Cb tree and Cr tree to save bits for signaling the syntax. For example, if the Cb tree shows high-depth for splitting results, then it will use higher probability for higher depth syntax for Cr tree partition signal coding.

This method is a content-dependent method. Therefore, it is proposed to turn on/off this method for different picture, slice, tile, CTU-row, CTU, or VPDU, the control flag for on/off is provided per picture, slice, tile, CTU-row, CTU, or VPDU. In other words, the syntax is signalled or parsed in picture level, a slice level, a tile level, a CTU-row level, a CTU level, a VPDU level or a combination thereof, and the syntax is related to indicating whether the Cr splitting tree is used to partition the Cr picture area separately from the Cb splitting tree at a corresponding picture, slice, tile, CTU-row, CTU or VPDU.

In another embodiment, the luma and Cb (or chroma component 1) samples can share one splitting tree and Cr (or chroma component 2) samples can use another separate splitting tree.

In another embodiment, the luma and Cr (or chroma component 2) samples can share one splitting tree and Cb (or chroma component 1) samples can use another separate splitting tree.

### Method B: CST for Inter and CU-Group-Based CCLM

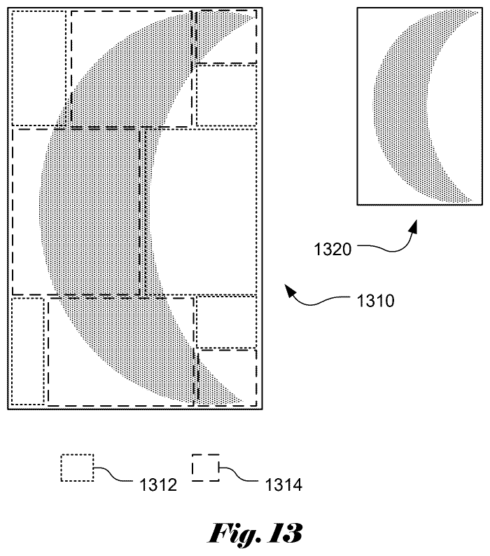

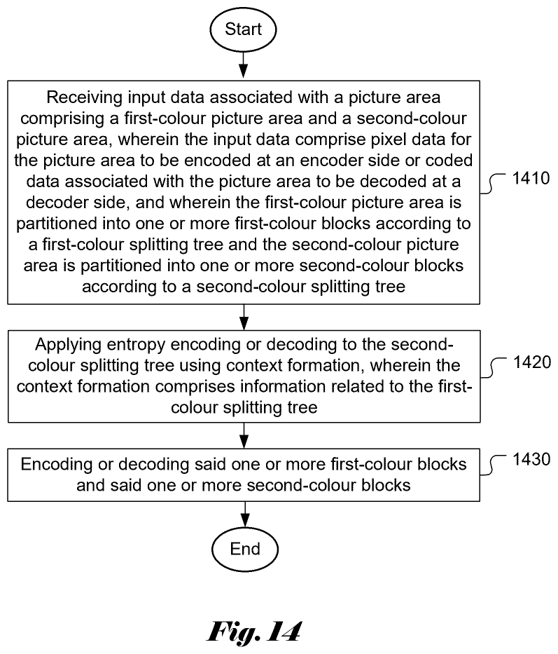

In this method, CST is applied to inter slice. The main benefit is that the CCLM part may achieve a large coding gain for the chroma part. As shown in FIG. 13, the luma and chroma can have different trees for an inter slice according to embodiments of the present invention. In FIG. 13, partition 1310 corresponds to the partition for the luma image, where the image is partitioned into various blocks for intra coding 1312 and inter coding 1314. As shown in FIG. 13, it will be more efficient to generate a chroma predictor as a whole parent block 1320. Therefore, the chroma may use a large block to generate the CCLM predictor so as to have better coding gain.

This method is a content-dependent method. Therefore, it is proposed to turn on/off for this method for different picture, slice, tile, CTU-row, CTU or VPDU, the control flag for on/off is provided per picture, slice, tile, CTU-row, CTU or VPDU.

### Method C: CST of Predictor and Residual

To improve the coding gain, it is proposed to separate the splitting tree for prediction and residual. In other words, starting from the root CU, it traverses one splitting tree to generate all predictors (for example, motion compensation and intra-prediction), and it traverses another splitting tree to generate all residual blocks (for example, inverse transform). Finally, all the predictor samples and residual samples are added together to generate the final reconstructed samples.

In one sub-embodiment, the CST for predictor and residual is only applied for all-inter-region. In other words, inside the root CU, all the predictions are inter-prediction.

This method will improve the coding gain. For the predictor, it will give the best predictor MV inheritance of one dedicated tree. For the residual, it will give the best residual block partition of one dedicated tree.

This method is a content-dependent method. Therefore, it is proposed to turn on/off for this method for different picture, slice, tile, CTU-row, CTU or VPDU, the control flag for on/off is provided per picture, slice, tile, CTU-row, CTU or VPDU.

### Method D: Split Probability Prediction Between CST Luma and Chroma

In VVC CST, the luma and chroma have their own splitting-information (due to separate trees) to perform entropy coding. For entropy coding, it needs related probability model for each splitting information signal. For a high-dense (high split) luma region, the corresponding chroma region usually is also a high dense (although the split trees may be different), there will be correlation between the splitting depth of the luma tree and the splitting depth of the chroma tree.

In one embodiment, it is proposed to refer to the split density of the luma tree to adjust the split signal probability model of the chroma region.

For example, for the current chroma parent node, if the corresponding spatial luma region has a high degree of splitting depth (i.e., split into very small CUs), then the probability of the higher-depth splitting syntax will be promoted for the probability.

For example, if the corresponding spatial luma region has a low degree of splitting depth (not split into very small CUs) for the current chroma parent node, then the probability of the higher-depth splitting syntax will be decreased for the probability.

In other embodiment, it is proposed to jointly consider the splitting situation of luma with the chroma splitting information for context formation. For example, when doing the context formation for the splitting flag of the current chroma parent CU/current CU, the context will also include the corresponding luma region splitting situation, such as quadtree depth, MTT depth, block dimension, etc. For example, the context formation is dependent on quadtree depth or MTT (Multi-Type Tree) depth related to the luma splitting tree, or block dimension related to said one or more luma blocks. A video coder may assign different context variables corresponding to different splitting situations and determine the selected context variable for entropy coding a split decision for a current chroma block. Therefore, the context formation for entropy coding a split decision for a current chroma block is dependent on splitting situation in a corresponding luma block. The process performed by the coder can be dependent on the splitting situation in the corresponding luma region. In one example, a video coder may select a modeling context for entropy coding a CU split flag of a current chroma block depending on the size of the corresponding luma block. In another example, a video coder may select modeling context for entropy coding an MTT vertical flag of a current chroma block depending on the dimension (e.g. width and height) of the corresponding luma block. For example, the dimension of the corresponding luma block may correspond to width, height or both the width and the height of the corresponding luma block.

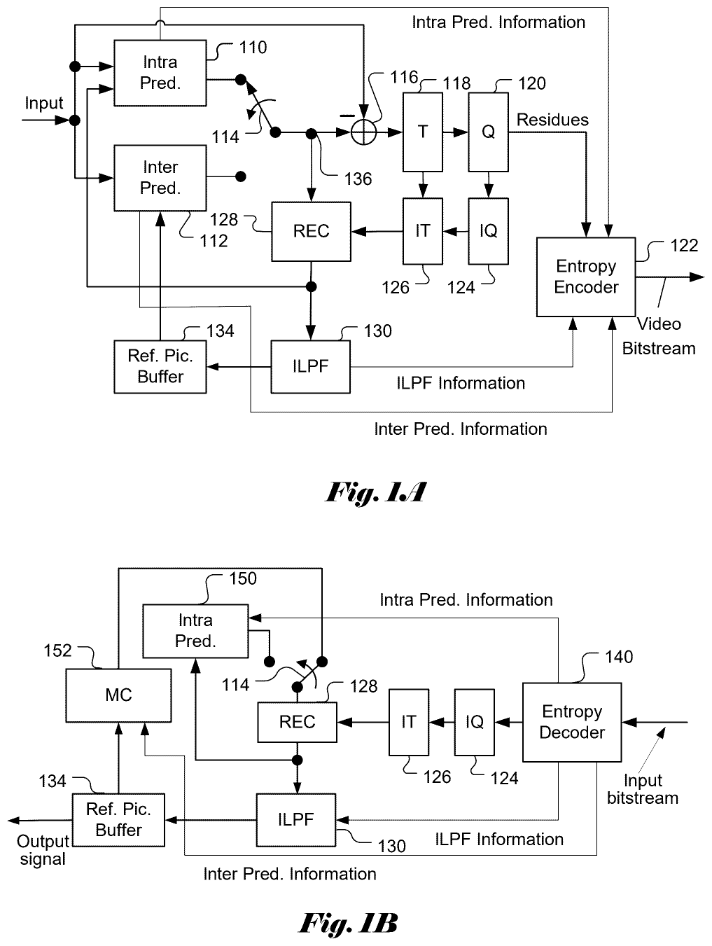

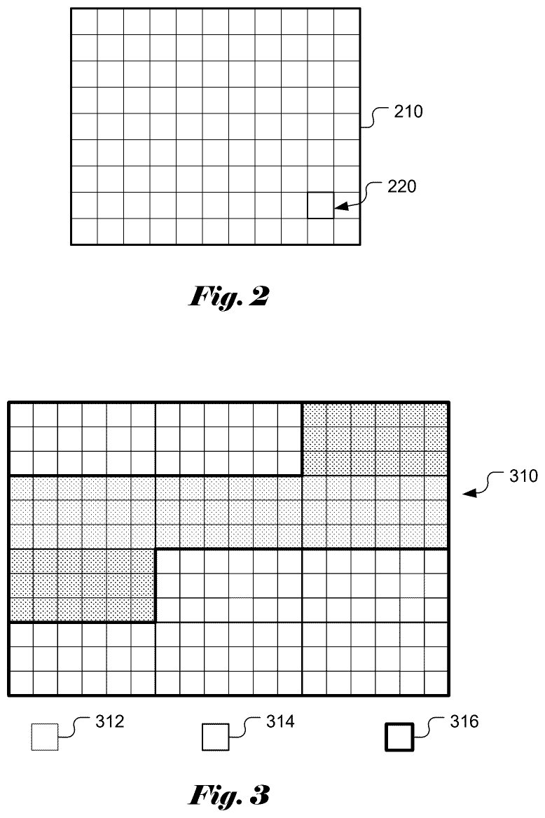

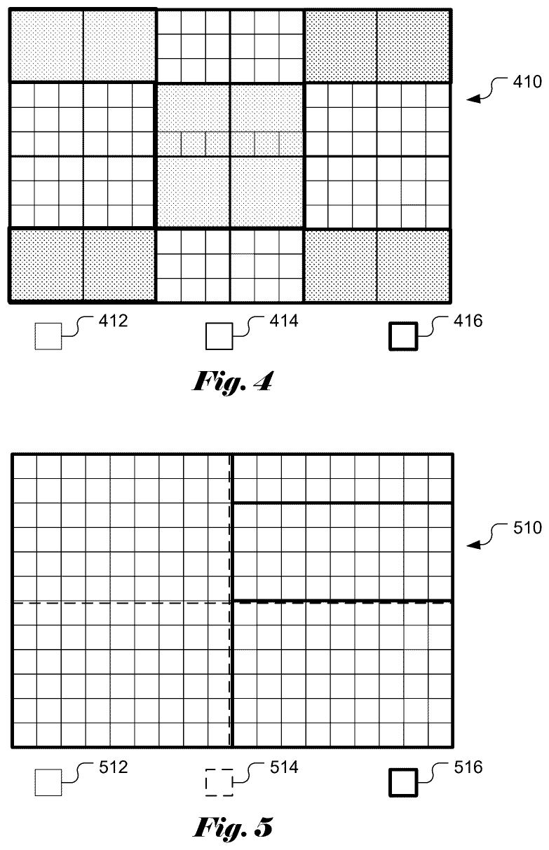

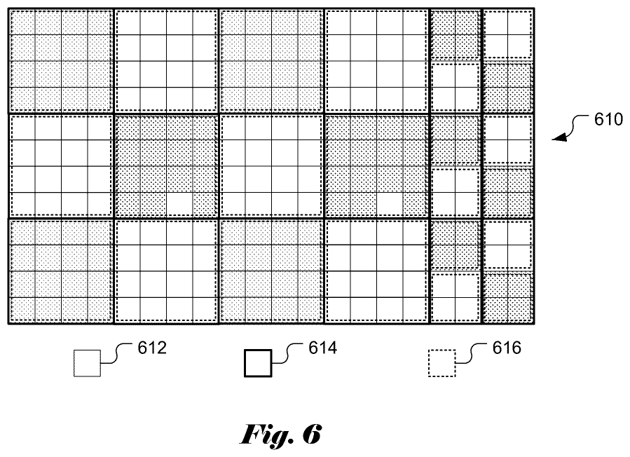

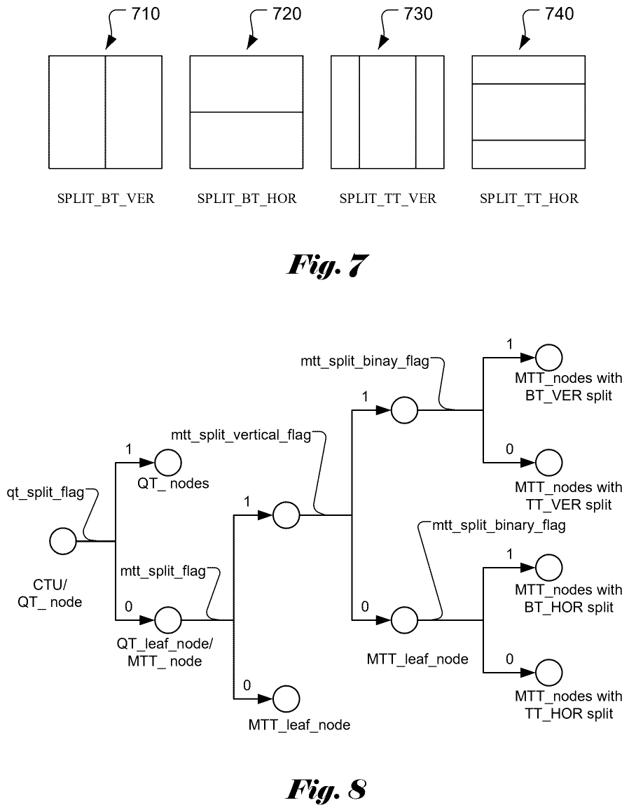

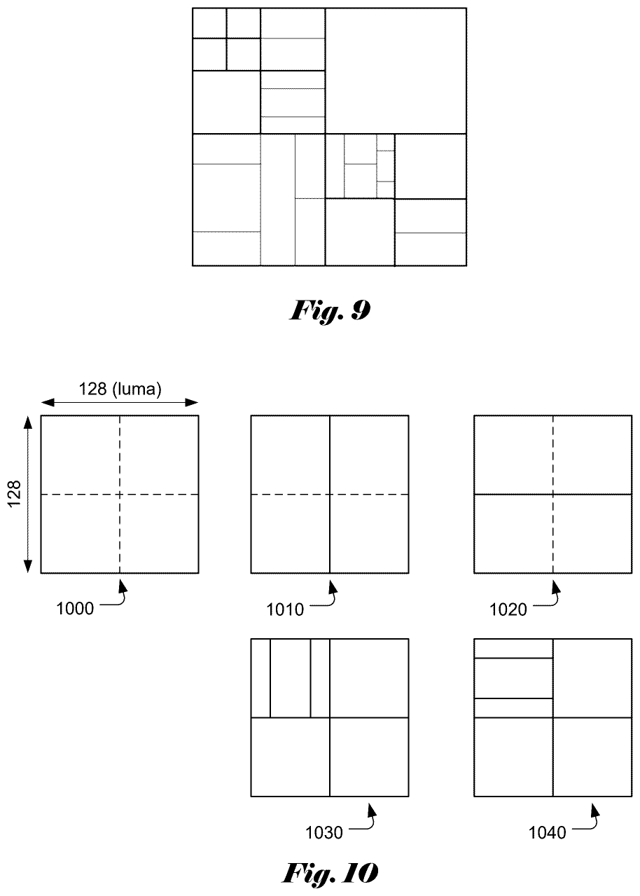

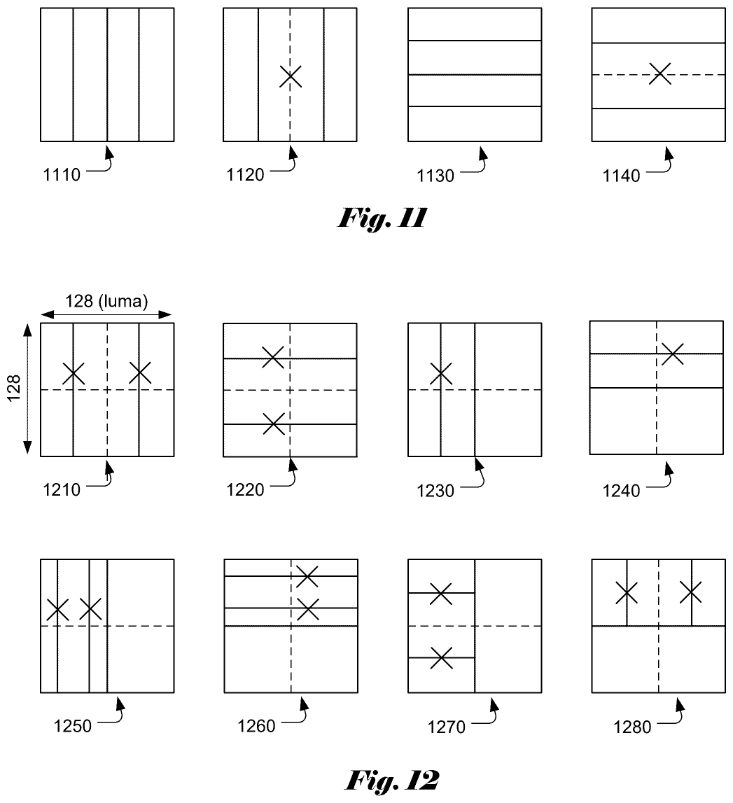

Any of the foregoing proposed CST (Chroma Separate Tree) methods can be implemented in encoders and/or decoders. For example, any of the proposed methods can be implemented in an intra (e.g. Intra 150 in FIG. 1B), a motion compensation module (e.g. MC 152 in FIG. 1B), or an entropy coding module (e.g. Entropy Decoder 140 in FIG. 1B) of a decoder. Also, any of the proposed methods can be implemented in intra (e.g. Intra 110 in FIG. 1A), inter coding module of an encoder (e.g. Inter Pred. 112 in FIG. 1B), or an entropy coding module (e.g. Entropy Encoder 122 in FIG. 1A) of the encoder. Alternatively, any of the proposed methods can be implemented as one or more circuits or processors coupled to the inter/intra/prediction/entropy coding modules of the encoder and/or the inter/intra/prediction/entropy coding modules of the decoder, so as to provide the information needed by the inter/intra/prediction module.

FIG. 14 illustrates a flowchart of an exemplary video coding system that utilizes separate splitting trees for luma and chroma components according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a picture area comprising a first-colour picture area and a second-colour picture area are received in step 1410, wherein the input data comprise pixel data for the picture area to be encoded at an encoder side or coded data associated with the picture area to be decoded at a decoder side, and wherein the first-colour picture area is partitioned into one or more first-colour blocks according to a first-colour splitting tree and the second-colour picture area is partitioned into one or more second-colour blocks according to a second-colour splitting tree. Entropy encoding or decoding is applied to the second-colour splitting tree using context formation in step 1420, wherein the context formation comprises information related to the first-colour splitting tree. Said one or more first-colour blocks and said one or more second-colour blocks are encoded or decoded in step 1430.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding for colour pictures, the method comprising:
receiving input data associated with a picture area comprising a first-colour picture area and a second-colour picture area, wherein the input data comprise pixel data for the picture area to be encoded at an encoder side or coded data associated with the picture area to be decoded at a decoder side, and wherein the first-colour picture area is partitioned into one or more first-colour blocks according to a first-colour splitting tree and the second-colour picture area is partitioned into one or more second-colour blocks according to a second-colour splitting tree;
applying entropy encoding or decoding to the second-colour splitting tree using context formation, wherein the context formation comprises information related to the first-colour splitting tree; and
encoding or decoding said one or more first-colour blocks and said one or more second-colour blocks.

2. The method of claim 1, wherein the context formation is dependent on quadtree depth or MTT (Multi-Type Tree) depth related to the first-colour splitting tree, or block dimension related to said one or more first-colour blocks.

3. The method of claim 1, wherein the context formation for entropy coding a split decision for a current second-colour block is dependent on splitting situation in a corresponding first-colour block.

4. The method of claim 1, wherein the context formation for entropy coding a split flag associated with a current second-colour block is dependent on a block size of a corresponding first-colour block.

5. The method of claim 1, wherein the context formation for entropy coding an MTT (Multi-Type Tree) vertical flag for a current second-colour block is dependent on dimension of a corresponding first-colour block.

6. The method of claim 5, wherein the dimension of the corresponding first-colour block corresponds to width, height or both the width and the height of the corresponding first-colour block.

7. The method of claim 1, wherein the first-colour picture area corresponds to a luma picture area and the second-colour picture area corresponds to a chroma picture area.

8. The method of claim 1, wherein the picture area comprises a third-colour picture area, and wherein the first-colour picture area corresponds to a luma picture area, the second-colour picture area corresponds to a first chroma picture area and the third-colour picture area corresponds to a second chroma picture area.

9. The method of claim 8, wherein the third-colour picture area is partitioned into one or more third-colour blocks according to a third-colour splitting tree separately from the second-colour splitting tree.

10. The method of claim 9, wherein a syntax is signalled or parsed in picture level, a slice level, a tile level, a CTU-row level, a CTU level, a VPDU level or a combination thereof, and wherein the syntax is related to indicating whether the third-colour splitting tree is used to partition the third-colour picture area separately from the second-colour splitting tree at a corresponding picture, slice, tile, CTU-row, CTU or VPDU.

11. An apparatus for video coding, the apparatus comprising one or more electronics or processors arranged to:
receive input data associated with a picture area comprising a first-colour picture area and a second-colour picture area, wherein the input data comprise pixel data for the picture area to be encoded at an encoder side or coded data associated with the picture area to be decoded at a decoder side, and wherein the first-colour picture area is partitioned into one or more first-colour blocks according to a first-colour splitting tree and the second-colour picture area is partitioned into one or more second-colour blocks according to a second-colour splitting tree;
apply entropy encoding or decoding to the second-colour splitting tree using context formation, wherein the context formation comprises information related to the first-colour splitting tree; and
encode or decode said one or more first-colour blocks and said one or more second-colour blocks.
